(19) United States
(12) Patent Application Publication
(10) Pub. No.: US 2025/0136790 A1
(43) Pub. Date: May 1, 2025

(54) ACRYLIC DAMPING ADDITIVES FOR FILLED THERMOPLASTICS

(71) Applicants: Dow Global Technologies LLC, Midland, MI (US); Rohm and Haas Company, Collegeville, PA (US)

(72) Inventors: Ian D. Robertson, Collegeville, PA (US); Hailan Guo, Warrington, PA (US); Manoj Gokul Nerkar, Schwenksville, PA (US)

(21) Appl. No.: 18/838,708

(22) PCT Filed: Feb. 14, 2023
(86) PCT No.: PCT/US2023/012965

§ 371 Date: Aug. 15, 2024

Related U.S. Application Data
(60) Provisional application No. 63/314,652, filed on Feb. 28, 2022.

(51) Int. Cl. C08K 9/12

(52) U.S. Cl. CPC C08K 9/12

(57) ABSTRACT

A sound damping composition comprises an acrylic vibrational damping polymer disposed on a surface of a filler. The acrylic vibrational damping polymer has a glass transition temperature, T_{g}, ranging from −60° C. to less than 10° C., as calculated by the Fox equation, and has a non-crosslinked component having a T_{g} less than −10° C. The weight ratio of the acrylic vibrational damping polymer to the filler is less than 1:1. A thermoplastic resin composition comprises the sound damping composition and a thermoplastic resin, where the sound damping composition is present in an amount of at least 10 wt % relative to the total weight of the thermoplastic resin composition. Articles produced from the resin composition are also disclosed.

### FIELD OF THE INVENTION

The present invention generally relates to acrylic additives and, more specifically, to acrylic damping additives for filled thermoplastics and filled thermoplastics comprising acrylic damping additives.

### DESCRIPTION OF THE RELATED ART

Rigid thermoplastics containing fillers are widely used in many markets for a variety of applications where noise, vibration and harshness, collectively referred to as NVH, is a critical performance metric. These rigid thermoplastics are typically highly filled with 10 to 50wt % mineral filler, such as calcium carbonate, talc, or mica.

For example, vinyl flooring filled with calcium carbonate or wollastonite is a rapidly growing market and includes multilayer resilient vinyl flooring such as luxury vinyl tile (LVT), stone polymer composite (SPC), solid polymer composite, rigid floor, waterproof polymer composite, or wood polymer composite (WPC), which has the appearance of hardwood or ceramic tile.

One of the major drawbacks of vinyl flooring, including resilient flooring, is that the sound of the vinyl flooring does not match the look. Vinyl resilient flooring has a distinct sound during its usage. During use, vinyl resilient flooring will emit noise either through movement within the room (heels clicking) or to a floor below the room (footsteps, furniture dragging). In both cases, the typical acoustic properties of vinyl flooring are not desirable. Wood is known to produce a characteristic sound within a room when walked on. Even though vinyl flooring may have a wood-like appearance, the sound it makes is unlike wood and ruins the illusion. In addition, there is a need to limit the amount of vibration transmitted through the floor to the room below. Specific applications such as medical facilities, schools, and libraries require low sound transmission.

Several strategies have been employed to improve the NVH performance of vinyl flooring, including adding thick elastomeric pads to the underside and using specialized acoustic fillers. Some manufacturers have designed their flooring to include a viscoelastic layer embedded in the structure, i.e., a constrained layer, which reduces vibrations, but is a costly solution that lacks desired performance. Other strategies employed require the use of an underlayment, such as rubber or cork sheets. The use of an underlayment requires an additional installation step that is labor intensive and the underlayment still may not meet the sound reduction target.

For example, U.S. Pat. No. 8,640,824 discloses a vinyl tile with a constrained acoustical portion comprising a crumb rubber component, a polyurethane foam, and a resin binder. The crumb rubber can be made from recycled tires or sneaker rubber.

U.S. Patent Application Publication No. 2014/0302294 discloses a constrained layer in an acoustical vinyl tile that comprises individual layers chosen from any variety of rubber, cork, and polyurethane foam.

U.S. Pat. No. 8,146,310 discloses a noise controlling system that comprises a system for controlling noise. The system comprises multiple layers including a net layer with multiple polymer filaments and air to create a void space.

These attempts to dampen noise require complex changes to existing production lines, as well as require multiple components to attenuate noise.

Alternative attempts have been made at sound damping through the use of additives. For example, WO 2016/130639 discloses the use of styrene-isobutylene-styrene block copolymers (BCPs) as additives to a blend of thermoplastic elastomers. Similarly, WO 2019/230872 discloses the use of styrene/isobutene BCPs as additives to improve damping performance.

JP 2017-186390 discloses dry acrylic core-shell particles for use in combination with curable materials on their own as a damping coating.

There is a great need for sound damping additives that can be easily incorporated into existing manufacturing processes, provide sound damping at low loading levels, minimizer the impact on other physical properties, and/or are cost effective.

### BRIEF SUMMARY OF THE INVENTION

The present invention provides a sound damping composition comprising an acrylic sound damping polymer disposed on a surface of a filler. The acrylic vibration damping polymer has a calculated glass transition temperature, T_{g}, ranging from −60° C. to less than 10° C., and has a non-crosslinked component having a T_{g} less than −10° C. The weight ratio of the acrylic vibrational damping polymer to the filler is less than 1:1.

The present invention also provides a thermoplastic resin composition comprising the sound damping composition and a thermoplastic resin. The sound damping composition is present in an amount of at least 10 wt % relative to the total weight of the thermoplastic resin composition.

The present invention also provides articles produced from the thermoplastic resin composition.

### A BRIEF DESCRIPTION OF THE DRAWINGS

FIG. 1 shows a diagram of the setup for performing center point excitation tests.

FIG. 2 shows a comparison of damping performance at 25° C. of examples according to embodiments of the invention and comparative examples.

### DETAILED DESCRIPTION OF THE INVENTION

The present invention provides a sound damping composition. The sound damping composition comprises an acrylic vibrational damping polymer and a filler. As used herein, an “acrylic vibrational damping polymer” refers to an acrylic polymer or copolymer that is capable of attenuating vibrations, or sound, particularly when used in a thermoplastic composition. The acrylic vibrational damping polymer may attenuate single frequencies of vibration, all frequencies or vibrations, or one or more bands of vibration frequencies. For example, the acrylic vibrational damping polymer may attenuate vibration frequencies created by footsteps when a person walks across the vinyl floor.

As used herein, the terms “glass transition temperature” or “Tg” refers to the temperature at or above which a glassy polymer will undergo segmental motion of the polymer chain. Glass transition temperatures of a copolymer can be estimated using the Fox equation (Bulletin of the American Physical Society, 1 (3) Page 123 (1956)) as follows:

$$1 / Tg = w 1 / Tg ( 1 ) + w 2 / Tg ( 2 )$$

For a copolymer, w1 and w2 refer to the weight fraction of the two comonomers, and Tg(1) and Tg(2) refer to the glass transition temperatures of the two corresponding homopolymers made from the monomers in degrees Kelvin. For polymers containing three or more monomers, additional terms are added (wn/Tg(n)). The glass transition temperatures of the homopolymers may be found, for example, in the “Polymer Handbook,” edited by J. Brandrup and E. H. Immergut, Interscience Publishers. The Tg of a polymer can also be measured by various techniques, including, for example, differential scanning calorimetry (“DSC”). As used herein, the phrase “calculated Tg” shall mean the glass transition temperature as calculated by the Fox equation. When the Tg of a multistage polymer is measured, more than one Tg may be observed. The Tg observed for one stage of a multistage polymer may be the same as the Tg that is characteristic of the polymer that forms that stage (i.e., the Tg that would be observed if the polymer that forms that stage were formed and measured in isolation from the other stages). When a monomer is said to have a certain Tg, it is meant that a homopolymer made from that monomer has that Tg.

The acrylic vibrational damping polymer has a calculated glass transition temperature, T_{g}, ranging from −60° C. to 20° C. as calculated by the Fox equation. The acrylic vibrational damping polymer has a glass transition temperature of at least −60° C., preferably at least −50° C., more preferably at least −40° C., even more preferably at least −35° C., and yet more preferably at least −30° C., as measured by DSC. The acrylic vibrational damping polymer has a calculated glass transition temperature of no more than 20° C., preferably no more than 10° C., more preferably no more than 0° C., still more preferably no more than −° C., and even more preferably no more than −10° C.

The acrylic vibrational damping polymer has a non-crosslinked component. The non-crosslinked component may be linear or branched, but contains substantially no crosslinking (i.e., less than 2 mol % of monomeric units in the non-crosslinked component are crosslinked). Preferably, the non-crosslinked component is linear. Preferably, the non-crosslinked component has a calculated glass transition temperature less than −10° C. Preferably, the non-crosslinked component comprises at least 50 wt % of the total weight of the acrylic vibration damping polymer, and more preferably, the non-crosslinked component comprises at least 70 wt % of the total weight of the acrylic vibration damping polymer.

The acrylic vibrational damping polymer may be a homopolymer or a copolymer, such as, for example a block copolymer. The acrylic vibrational damping polymer may be 100 wt % acrylic or may comprise a non-acrylic component (i.e., non-acrylic structural units). When a non-acrylic component is used, the acrylic component is preferably at least 50 wt % of the total weight of the acrylic vibrational damping polymer, more preferably at least 60 wt %, even more preferably at least 70 wt %, and still more preferably at least 80 wt % of the total weight of the acrylic vibrational damping polymer.

The acrylic vibrational damping polymer may comprise one or more structural units (i.e., the remnant of the monomer after polymerization) selected from α, β-ethylenically unsaturated carboxylic acid monomers and ethylenically unsaturated nonionic monomers. Examples of suitable α, β-ethylenically unsaturated carboxylic acid monomers include monobasic acids such as (meth)acrylic acid, crotonic acid, and acyloxypropionic acid; and dibasic acid monomers such as maleic acid, fumaric acid, and itaconic acid; or mixtures thereof. Preferred α, β-ethylenically unsaturated carboxylic acid monomers include acrylic acid, methacrylic acid, or mixtures thereof. Examples of ethylenically unsaturated nonionic monomers include, for example, alkyl esters of (meth) acrylic acids including C1-C18 and preferably C1-C12 alkyl esters of (meth) acrylic acids such as methyl acrylate, ethyl acrylate, butyl acrylate, 2-ethylhexyl acrylate, decyl acrylate, lauryl acrylate, methyl methacrylate, butyl methacrylate, isodecyl methacrylate, lauryl methacrylate, hydroxy-functional (meth)acrylic acid alkyl ester such as hydroxyethyl (meth)acrylate and hydroxypropyl (meth)acrylate. Preferred ethylenically unsaturated nonionic monomers are butyl acrylate, butyl methacrylate, methyl methacrylate, 2-ethylhexyl acrylate, decyl acrylate, lauryl acrylate, isodecyl methacrylate, lauryl methacrylate, and mixtures thereof.

The acrylic vibrational damping polymer may also comprise one or more structural units derived from functionalized monomers. For example, the acrylic vibrational damping polymer may comprise structural units derived from at least one organo-phosphorus monomer. The organo-phosphorus monomer may be in the acid form or as a salt of the phosphorus acid groups. Examples of organo-phosphorus monomers include:

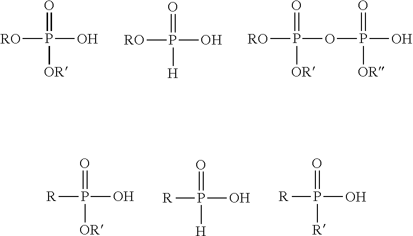

where R is an organic group containing an acryloxy, methacryloxy, or a vinyl group, and R′ and R″ are independently selected from H and a second organic group. The second organic group may be saturated or unsaturated. Suitable organo-phosphorus monomers include dihydrogen phosphate-functional monomers such as dihydrogen phosphate esters of an alcohol in which the alcohol also contains a polymerizable vinyl or olefinic group, such as allyl phosphate, mono-or diphosphate of bis(hydroxy-methyl) fumarate or itaconate, derivatives of (meth)acrylic acid esters, such as, for examples phosphates of hydroxyalkyl(meth)acrylates including 2-hydroxyethyl (meth)acrylate, 3-hydroxypropyl (meth)acrylates, and the like.

Other suitable organo-phosphorous monomers include CH₂═C(R)—C(O)—O—(R′O)ₙ—P(O)(OH)₂, where R═H or —CH₃, R′=alkyl, and n=1 to 5, such as the methacrylates SIPOMER™ PAM-100, SIPOMER™ PAM-200, SIPOMER™ PAM-400, SIPOMER™ PAM-600 and the acrylate, SIPOMER™ PAM-300, available from Solvay.

Other suitable organo-phosphorus monomers are phosphonate functional monomers, disclosed in WO 99/25780 A1, and include vinyl phosphonic acid, allyl phosphonic acid, 2-acrylamido-2-methylpropanephosphonic acid, α-phosphonostyrene, 2-methylacrylamido-2-methylpropanephosphonic acid. Further suitable organo-phosphorus monomers are 1,2-ethylenically unsaturated (hydroxy)phosphinylalkyl (meth)acrylate monomers, disclosed in U.S. Pat. No. 4,733,005, and include (hydroxy) phosphinylmethyl methacrylate.

Preferably, the organo-phosphorus monomers comprise at least one compound of formula CH₂═C(R)—C(O)—O—(R′O)ₙ—P(O)(OH)₂. More preferably, R is —CH₃, R′ is an alkyl group comprising 1 to 6 carbon atoms, and n=1.

In a preferred embodiment, the acrylic vibrational damping polymer comprises a phosphate functionalized linear acrylic copolymer comprising structural units derived from phosphoethylmethacrylate (PEM).

The acrylic vibrational damping polymer may comprise one or more structural units selected from a compound of formula R′SiOR₃, where R is hydrogen or a group comprising 1 to 6 carbon atoms, and R′ is a substituted or unsubstituted alkyl group comprising 1 to 12 carbon atoms, preferably 1 to 6 carbon atoms.

The acrylic vibrational damping polymer may comprise other structural units, such as, for example, amines (e.g., R₃₋ₙNHₙ, where R is a substituted or unsubstituted alkyl group comprising 1 to 12 carbon atoms and n is an integer from 0 to 3), or a functionalized (meth) acrylate (e.g., glycidyl methacrylate).

Other non-acrylic components that may be present in the acrylic vibrational damping polymer include structural units selected from styrene and substituted styrenes; butadiene; ethylene, propylene, a-olefins such as 1-decene; and vinyl monomers such as vinyl acetate, vinyl butyrate, vinyl chloride, vinylidene chloride, vinyl versatate and other vinyl esters; or combinations thereof.

Examples of acrylic vibrational damping polymers comprising a non-acrylic component include, but are not limited to styrene/acrylic copolymers and polyvinylacetate/acrylic copolymers.

The sound damping composition further comprises a filler. The acrylic vibrational damping polymer is disposed on a surface of the filler. As used herein, the term “disposed on a surface” means that the acrylic vibrational damping polymer is formed or deposited on the surface of the filler. The acrylic vibrational damping polymer may be bound, adhered or fused to the surface of the filler. Without wishing to be limited by theory, it is believed that the low Tg of the acrylic vibrational damping polymer makes it difficult to provide in a flowable solid form, such as powder. Therefore, the acrylic vibrational damping polymer is disposed on the surface of the filler. Particles of the filler may be coated with the acrylic vibrational damping polymer or comprise the acrylic vibrational damping polymer fused to the surface of the filler.

The filler may be a single filler or a combination of two or more fillers that differ in at least one property such as type of filler, method of preparation, treatment or surface chemistry, filler composition, filler shape, filler surface area, average particle size, and/or particle size distribution.

The shape and dimensions of the filler is also not specifically restricted. For example, the filler may be spherical, rectangular, ovoid, irregular, and may be in the form of, for example, a powder, a flour, a fiber, a flake, a chip, a shaving, a strand, a scrim, a wafer, a wool, a straw, a particle, and combinations thereof. Dimensions and shape are typically selected based on the type of the filler utilized, the selection of other components included within the composition, and the end use application of the polymer composite article formed therewith.

Non-limiting examples of fillers include quartz and/or crushed quartz, aluminum oxide, magnesium oxide, silica (e.g. fumed, ground, precipitated), hydrated magnesium silicate, magnesium carbonate, dolomite, silicone resin, wollastonite, soapstone, kaolinite, kaolin, mica muscovite, phlogopite, halloysite (hydrated alumina silicate), aluminum silicate, sodium aluminosilicate, glass (fiber, beads or particles, including recycled glass, e.g. from wind turbines or other sources), clay, magnetite, hematite, calcium carbonate such as precipitated, fumed, and/or ground calcium carbonate, calcium sulfate, barium sulfate, calcium metasilicate, zinc oxide, talc, diatomaceous earth, iron oxide, clays, mica, chalk, titanium dioxide (titania), zirconia, sand, carbon black, graphite, anthracite, coal, lignite, charcoal, activated carbon, non-functional silicone resin, alumina, silver, metal powders,, magnesium oxide, magnesium hydroxide, magnesium oxysulfate fiber, aluminum trihydrate, aluminum oxyhydrate, coated fillers, carbon fibers (including recycled carbon fibers, e.g. from the aircraft and/or automotive industries), poly-aramids such as chopped KEVLAR™ or Twaron™, nylon fibers, mineral fillers or pigments (e.g. titanium dioxide, non-hydrated, partially hydrated, or hydrated fluorides, chlorides, bromides, iodides, chromates, carbonates, hydroxides, phosphates, hydrogen phosphates, nitrates, oxides, and sulfates of sodium, potassium, magnesium, calcium, and barium); zinc oxide, antimony pentoxide, antimony trioxide, beryllium oxide, chromium oxide, lithopone, boric acid or a borate salt such as zinc borate, barium metaborate or aluminum borate, mixed metal oxides such as vermiculite, bentonite, pumice, perlite, fly ash, clay, and silica gel; rice hull ash, ceramic and, zeolites, metals such as aluminum flakes or powder, bronze powder, copper, gold, molybdenum, nickel, silver powder or flakes, stainless steel powder, tungsten, barium titanate, silica-carbon black composite, functionalized carbon nanotubes, cement, slate flour, pyrophyllite, sepiolite, zinc stannate, zinc sulphide), and combinations thereof. Preferably, the filler is selected from the group consisting of calcium carbonate, glass fibers, carbon fibers, mica, graphite, talc, kaolin, aluminum trihydrate, and combinations thereof. More preferably, the filler comprises calcium carbonate.

The weight ratio of the acrylic vibrational damping polymer to the filler in the sound damping composition is less than 1:1 based on the total weight of the acrylic damping polymer and filler in the sound damping composition. Preferably the weight ratio of the acrylic vibrational damping polymer to the filler in the sound damping composition is less than 1:2, more preferably less than 1:3, and even more preferably less than 1:4 based on the total weight of the acrylic damping polymer and filler in the sound damping composition.

Preferably, the sound damping composition is in the form of a powder.

A further aspect of the present invention relates to a thermoplastic resin comprising the sound damping composition and a thermoplastic resin. The thermoplastic resin may be selected from the group consisting of polyvinyl chloride, polypropylene, acrylic, polyester, polycarbonate, polyethylene, and polyphenylene oxide. Preferably, the thermoplastic resin is selected from polyvinyl chloride and acrylic. More preferably, the thermoplastic resin comprises polyvinyl chloride.

The sound damping composition is present in an amount of at least 10 wt % relative to the total weight of the thermoplastic resin composition. More preferably, the sound damping composition is present in an amount of at least 15 wt % relative to the total weight of the thermoplastic resin composition. For example, the sound damping composition may be present in an amount of at least 20 wt % or 25 wt % relative to the total weight of the thermoplastic resin composition.

Preferably, the acrylic vibrational damping polymer is present in an amount ranging from 0.5 to 15 wt % relative to the total weight of the thermoplastic resin composition. Preferably, the acrylic vibrational damping polymer is present in an amount less than 10 wt %, more preferably less than 7 wt %, even more preferably less than 6 wt %, and still more preferably less than 5 wt % relative to the total weight of the thermoplastic resin composition.

Preferably, the filler is present in an amount ranging from 10 wt % to 60 wt % relative to the total weight of the thermoplastic resin composition. Preferably, the filler is present in an amount of at least 15 wt %, and more preferably of at least 20 wt % relative to the total weight of the thermoplastic resin composition.

The thermoplastic resin composition may be used to produce articles, such as floor tiles. Floor tiles often comprise thermoplastic resins, such as polyvinyl chloride, in at least one layer. The sound damping composition of the present invention may be incorporated into the thermoplastic resin using existing manufacturing processes. The sound damping composition can be added in powdered form as an additive during compounding of filled thermoplastics. By incorporating the sound damping composition of the present invention into a polyvinyl chloride floor tile, sound damping performance can be significantly improved, even with substantially small amounts of the acrylic vibrational damping polymer present.

### EXAMPLES

Polyvinyl chloride (PVC) composites with CaCO₃ filler were prepared with 6 different polymer additives and a control was prepared with no additives. The additives are listed below in Table 1.

TABLE 1

| | Acrylic Vibrational | T_{g} of Acrylic |
|---|---|---|
| | Damping | Vibrational |
| Sample | Polymer | Damping Polymer |
| Example 1 | Acrylic Polymer | −37° C. |
| Example 2 | Styrene Acrylic Polymer | −23° C. |
| Example 3 | Acrylic Polymer | −14° C. |
| Example 4 | Acrylic Polymer | −3° C. |
| Comparative Example 1 | None | — |
| Comparative Example 2 | Acrylic Polymer | 10° C. |
| Comparative Example 3 | Crosslinked Acrylic Polymer | −32° C. |

Samples were prepared by creating a slurry of roughly 50 vol % calcium carbonate (Durcal 10) in water, adding the waterborne acrylic vibrational damping polymer, and drying the slurry to form a homogenous powder. The powder was then compounded into a PVC masterbatch.

The composites were prepared at 2 levels of CaCO₃ loading, 95 parts weight per hundred resin (phr) and 133 phr. The formulations were prepared as follows:

TABLE 2

| Material | Manufacturer/Supplier | PHR |
|---|---|---|
| Formosa F622R | Formosa Plastics Corporation | 100 |
| TM 181 | PMC Vinyl Additives | 1.50 |
| Calcium Stearate | Norac Additives | 1.00 |
| F1020 | PMC Vinyl Additives | 0.90 |
| 165F Paraffin Wax | Rheogistics | 0.50 |
| AC629 | Honeywell | 0.50 |
| K445 | Dow | 9.00 |
| K175 | Dow | 1.00 |
| Sound damping | | 140 |
| composition | | |

The exemplary polyvinyl chloride master batch powder formulations were prepared by adding the materials in Table 2 sequentially. A master batch was prepared in around 20 minutes by adding the PVC at room temperature to a Gunther Papenmeier/Welex blender, ramping the power to 15A, adding TM 181 at 125° F., adding the lubricant package at 150° F., adding acrylic processing aids at 190° F., and adding the sound damping composition at 195° F. The above formulated PVC master batch was milled at 190° C. for 3 minutes on an electric Collin Roll mill with a 0.3 mm gap, then the milled sheet was compression molded to 3.2 mm thick plaque at 190° C.

### Damping Tests-DMA

The plaques were tested on the TA Instruments Q-800 Dynamic Mechanical Analyzer (DMA) using single cantilever clamp fixtures. The plaques were cut into the exact dimensions needed for this geometry, and the width and thicknesses were measured for each sample and input into the program. The length was fixed at 17.5 mm because of the geometry of the clamp. The sample was placed in the back portion of the clamp nearest the thermocouple and tightened in the order center clamp first, then end clamp. A calibrated torque wrench was used at 10 lbs force. The plaques were tested in the range of 0° C. to 180° C., at a heating rate of 2° C./min using the Temp Ramp/Freq Sweep Test in the DMA Multi-Frequency-Strain Mode. The applied frequency was 1 Hz. The Procedure Parameters were as follows: Applied Strain=0.002% and a Soak Time of 5 minutes was employed before the start of data acquisition. The dynamic storage and loss moduli (E′ and E″ respectively) as well as tan δ were recorded as a function of temperature. Each sample was run in duplicate as two plaques were provided. For initial screening, samples were tested by dynamic mechanical analysis. The DMA tests showed that the damping performance of the inventive examples had increased notable compared to the control (Comparative Example 1).

### Damping Tests-Center Point Excitation

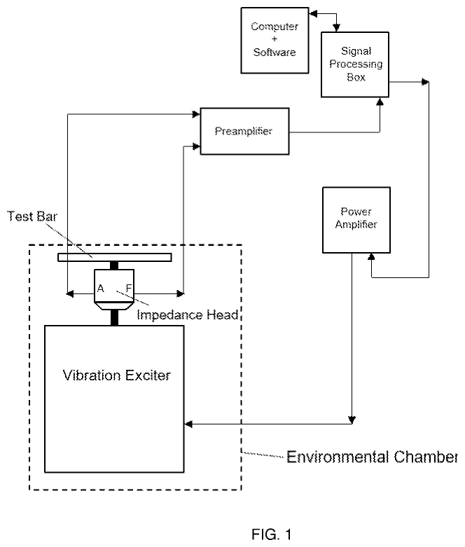

To explore the full mechanical damping response of the composites, PVC samples were tested using the center impedance method commonly employed to assess damping. Testing was performed in accordance with JIS G 0602-1993 for center-supporting, steady exciting methods. However, a homogenous damped bar was used instead of a coated one, with slightly altered dimensions. Sample plaques were cut into 10×1 inch bars and a metal mounting quill was superglued to the center of the bar. The quill was then screwed onto an impedance head attached to a mechanical vibration exciter unit as shown in FIG. 1. The vibration device with attached bar was placed in an environmental chamber to allow testing at 25° C. The bar was excited using white noise and the frequency response function was captured from 0-5000 Hz. For these samples, this allowed measurement of the composite loss factor or CLF of modes 1-5. CLF was calculated using the 3 dB down technique for each mode.

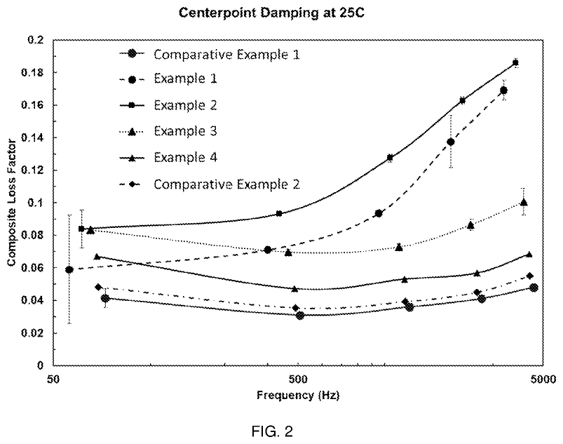

To demonstrate the significance of the glass transition temperature of the acrylic vibrational damping polymer, the center point damping test was performed on samples having a range of glass transition temperatures. Samples have a glass transition temperature ranging from −37° C. to 10° C. were tested against a control (Comparative Example 1) having no acrylic vibrational damping polymer. As shown in FIG. 2 and Table 3, the damped samples using an acrylic vibrational damping polymer having a glass transition temperature less than 0° C. performed significantly better at a test temperature of 25° C. than the damped sample (Comparative Example 2) having a glass transition temperature of 10° C., which performed about the same as the undamped control sample (Comparative Example 1).

TABLE 3

| | Composite Loss Factor (CLF) | | | | | | |
|---|---|---|---|---|---|---|---|
| Mode | Example | Example | Example | Example | Comparative | Comparative | Comparative |
| Number | 1 | 2 | 3 | 4 | Example 1 | Example 2 | Example 3 |
| 1 | 0.059 | 0.084 | 0.083 | 0.067 | 0.041 | 0.048 | 0.028 |
| 2 | 0.071 | 0.093 | 0.070 | 0.047 | 0.031 | 0.035 | 0.032 |
| 3 | 0.093 | 0.127 | 0.073 | 0.053 | 0.036 | 0.039 | 0.052 |
| 4 | 0.138 | 0.163 | 0.086 | 0.057 | 0.041 | 0.045 | .043 |
| 5 | 0.169 | 0.186 | 0.100 | 0.069 | 0.048 | 0.055 | |
| AVERAGE | 0.106 | 0.131 | 0.082 | 0.058 | 0.039 | 0.045 | 0.039 |
| CLF | | | | | | | |

To demonstrate the significance of crosslinking of the acrylic vibrational damping polymer, a highly crosslinked acrylic polymer with Tg −32° C. (Comparative Example 3) was tested as a comparison to the non-crosslinked acrylic polymers. The highly crosslinked sample performed similarly to the control, despite having a low Tg—indicating both glass transition temperature and polymer architecture are critical to performance.

Finally, to demonstrate the effect of polymer loading, samples based on Example 1-3 were prepared with half the amount of damping polymer were prepared and compared to Comparative Example 1. As shown in Table 4, the results show that reducing the amount of damping polymer reduces the damping performance, though some benefit is still observed compared to the control.

TABLE 4

| Mode | Example | Example | Example | Comparative |
|---|---|---|---|---|
| Number | 1 | 2 | 3 | Example 1 |
| 1 | 0.058 | 0.061 | 0.051 | 0.033 |
| 2 | 0.059 | 0.078 | 0.050 | 0.031 |
| 3 | 0.079 | 0.096 | 0.055 | 0.037 |
| 4 | 0.096 | 0.128 | 0.059 | 0.042 |
| 5 | 0.127 | 0.144 | 0.067 | 0.046 |
| AVERAGE | 0.084 | 0.101 | 0.056 | 0.038 |
| CLF | | | | |

In addition to the improved properties, the Examples according to embodiments of the present invention also exhibited improved processability by sticking less to the equipment and providing uniform mixing/dispersion of filler.

### Definitions and Usage of Terms

Unless otherwise indicated by the context of the specification, all amounts, ratios and percentages are by weight, and all test methods are current as of the filing date of this disclosure. The articles “a”, “an” and “the” each refer to one or more. It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Further, any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The term “composition,” as used herein, includes material(s) which comprise the composition, as well as reaction products and decomposition products formed from the materials of the composition.

The term “comprising,” and derivatives thereof, is not intended to exclude the presence of any additional component, step or procedure, whether or not the same is disclosed herein. In order to avoid any doubt, all compositions claimed herein through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

The term “polymer,” as used herein, refers to a polymeric compound prepared by polymerizing monomers, whether of the same or a different type. The generic term polymer thus embraces the term homopolymer (employed to refer to polymers prepared from only one type of monomer, with the understanding that trace amounts of impurities can be incorporated into the polymer structure), and the term copolymer (employed to refer to polymers prepared from more than one type of monomer). Trace amounts of impurities may be incorporated into and/or within the polymer.

“Blend”, “polymer blend” and like terms mean a composition of two or more polymers. Such a blend may or may not be miscible. Such a blend may or may not be phase separated. Such a blend may or may not contain one or more domain configurations, as determined from transmission electron spectroscopy, light scattering, x-ray scattering, and any other method known in the art. Blends are not laminates, but one or more layers of a laminate may contain a blend.

1. A sound damping composition comprising:
an acrylic vibrational damping polymer, wherein the acrylic vibrational damping polymer has a calculated glass transition temperature, T_{g}, ranging from −60° C. to less than 10° C., as calculated by the Fox equation, and has a non-crosslinked component, wherein the non-crosslinked component has a calculated T_{g} less than −10° C.; and
a filler;
wherein the acrylic vibrational damping polymer is disposed on a surface of the filler, and wherein the weight ratio of the acrylic vibrational damping polymer to the filler is less than 1:1.

2. The composition of claim 1, wherein the composition is in the form of a powder.

3. The composition of claim 1, wherein the acrylic vibrational damping polymer comprises a styrene/acrylic copolymer or a polyvinylacetate/acrylic copolymer.

4. The composition of claim 1, wherein the acrylic vibrational damping polymer comprises a phosphate functionalized linear acrylic copolymer.

5. The composition of claim 1, wherein the filler is selected from the group consisting of calcium carbonate, glass fibers, carbon fibers, mica, graphite, talc, kaolin, aluminum trihydrate, and combinations thereof.

6. The composition of claim 1, wherein the filler comprises calcium carbonate.

7. The composition of claim 1, wherein the weight ratio of the acrylic vibrational damping polymer to the filler is less than 1:2.

8. The composition of claim 1, wherein the weight ratio of the acrylic vibrational damping polymer to the filler is less than 1:4.

9. The composition of claim 1, wherein the acrylic vibration damping polymer has a calculated glass transition temperature, T_{g}, ranging from −40° C. to 0° C.

10. The composition of claim 1, wherein the acrylic vibration damping polymer has a calculated glass transition temperature, T_{g}, ranging from −40° C. to −5° C.

11. A thermoplastic resin composition comprising:
the sound damping composition of any one of the preceding claims; and
a thermoplastic resin;
wherein the sound damping composition is present in an amount of at least 10 wt % relative to the total weight of the thermoplastic resin composition.

12. The thermoplastic resin composition of claim 11, wherein the thermoplastic resin is selected from the group consisting of polyvinyl chloride, polypropylene, acrylic, polyester, polycarbonate, polyethylene, and polyphenylene oxide.

13. The thermoplastic resin composition of claim 11, wherein the sound damping composition is present in an amount of at least 15 wt % relative to the total weight of the thermoplastic resin composition.

14. An article produced from the thermoplastic resin composition of claim 11.

15. The article of claim 14, wherein the article is a floor tile.
